(19) United States
(12) Patent Application Publication
(10) Pub. No.: US 2004/0098929 A1
(43) Pub. Date: May 27, 2004

(54) Crawl access and basement window well

(76) Inventors: Bronson B. Kim, Tacoma, WA (US); Dale A. Wetmore, Graham, WA (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 09/997,046

(22) Filed: Nov. 28, 2001

(51) Int. Cl. E06B 5/02; E04F 17/06

(52) U.S. Cl. 52/107

(57) ABSTRACT

A window well structure for protecting crawl space access or basement windows. A molded plastic window well structure is provided in a variety of colors. The structure is easily cut at grooves between adjacent corrugations, to provide a desired height, either singularly by affixing two such structures together with fasteners between the top rim of a first structure and the bottom rim of a second structure. Inward facing flanges are provided to assist in ease of installation and to enable visual inspection of the attachment as the installation ages.

### TECHNICAL FIELD

This invention relates to window wells, typically used in foundations in residential and light commercial construction, and more particularly, to window wells that can be easily provided in a desired height for use in with a foundation wall of preselected height requirements.

### BACKGROUND

In residential and light commercial construction, it is common practice to provide, either in a poured concrete foundation wall or in a fabricated steel structure, an opening for access to either basement windows, or to a crawl space beneath the building structure. Many workable crawl access and basement window well wall structures (hereinafter, “window well structures”) have been developed thru the years for such applications.

However, it would still be quite desirable to reduce the overall costs that must necessarily be incurred in the manufacture and distribution of such window well structures. Also, labor saving techniques, or changes in the apparatus which would reduce the overall cost of installation, would be welcome by the contractors charged with installing such window well structures.

We are aware of various attempts in which an effort has been made to provide an improved window well structure. One of the designs which resembles the instant invention to some remote extent is disclosed by Kemp, in U.S. Pat. No. 4,704,828, issued Nov. 10, 1987, for a SNAP TOGETHER WINDOW WELL. He shows a window well structure that is fastened together from two similar portions via the use of two superposed unshaped sections made of sheet metal. However, he does not provide a design that includes the feature of being able to cut the base structure to a desired height for fitting a selected building structure. Nor does his window well structure provide for either ended fitting of a window well structure to a building structure, since his structure is manufactured with a definite up and down end. Thus, the advantages of our simple, cuttable, reversible window well structure, which is made with portions that can be mated and fastened together as necessary for providing a desired window well structure height in a pre-selected width, to provide a strong, substantially leak resistant window well structure, which is safe from corrosion and thus environmentally friendly, are important and self evident.

### BRIEF DESCRIPTION OF DRAWING

In order to enable the reader to attain a more complete appreciation of the invention, and of the novel features and the advantages thereof, attention is directed to the following detailed description when considered in connection with the accompanying drawings, wherein:

FIG. 1 is a perspective view of a well vent structure fabricated in accord with the principles disclosed herein, showing the corrugated plastic body between upper and lower rims, and between first and second flanges, in place next to a building structure to protect a basement window against adjacent earth.

FIG. 2 provides a perspective view of the use of “reversible” two way fastener receiving openings in the inwardly facing flanges provided in the window well structure, showing the use of a nail to attach the window well structure to a building structure.

FIG. 3 provides a perspective view of a pair of window well structure, showing in detail how a first and a second window well structure may be joined at lower and upper flanges to provided a stacked window well structure of desired height; also note that by cutting the plastic window well structure at a selected groove, between corrugations, the first or second window well structure can be sized to a selected height, to produce an assembled window well structure of desired overall height.

FIG. 4 provides a side elevation view of a portion of an inwardly opening attachment flange or rim, showing the “reversible” two way fastener receiving openings in the inwardly facing flange for attachment of the window well structure to an adjacent building structure.

FIGS. 5A, 5B, 5C, 5D, 5E, 5F, 5G, 5H, and 5I represent alternate colors for the material used to manufacture the plastic window well structure described herein.

FIG. 6 is a perspective view similar to FIG. 3, but now showing the assembly of a first window well structure and a second window well structure after the upper structure has been cut between corrugations along a smooth, relatively flat spot between horizontal sectioning grooves.

FIG. 7 is a side elevation view, taken looking at the outside surface of corrugated body at one inward end of the generally U-shaped open end of a window well structure, taken as if along line 7-7 of FIG. 3, here indicated that the outward edge end of the flange also defines the ends of the corrugated body.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, various other elements of the window wells are also shown and briefly described to enable the reader to understand how various features, including optional or alternate features, may be utilized in order to provide a compact, efficiently constructible window well or crawl space access well structure of desired overall height and which can be manufactured of a long lasting material in a desired color.

### DETAILED DESCRIPTION

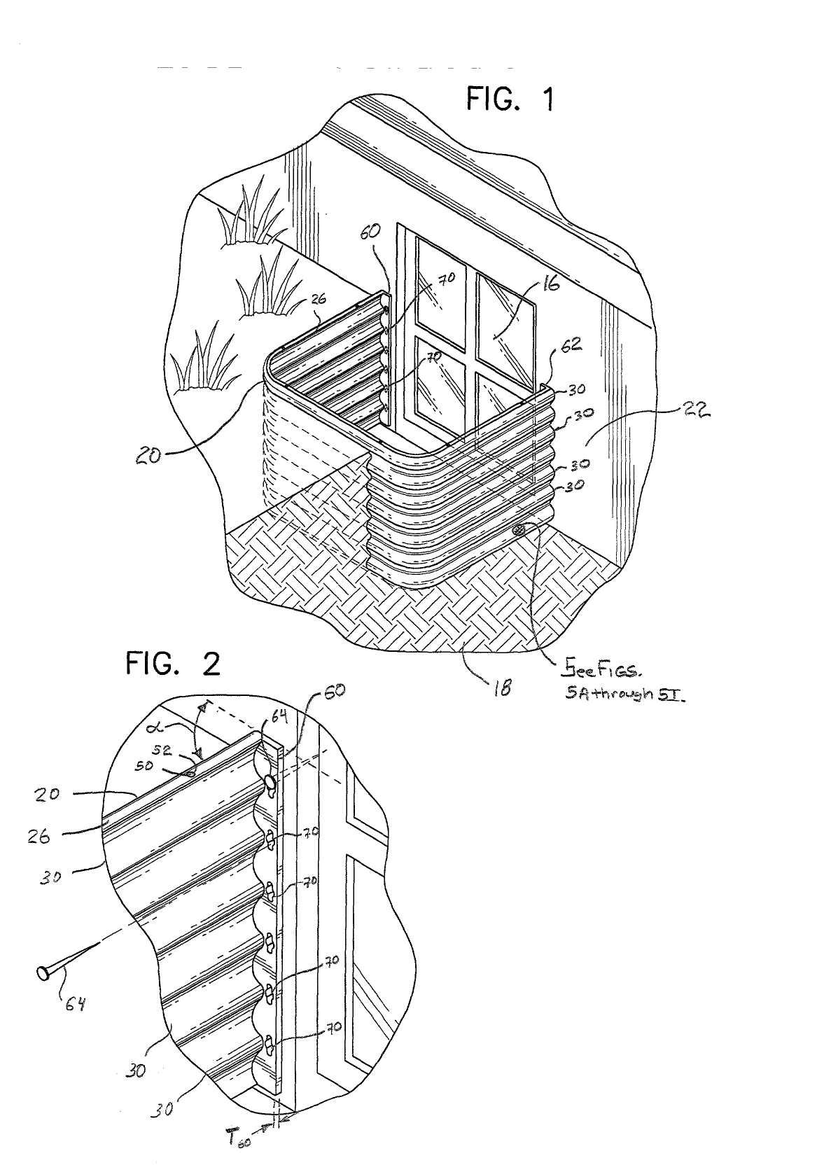

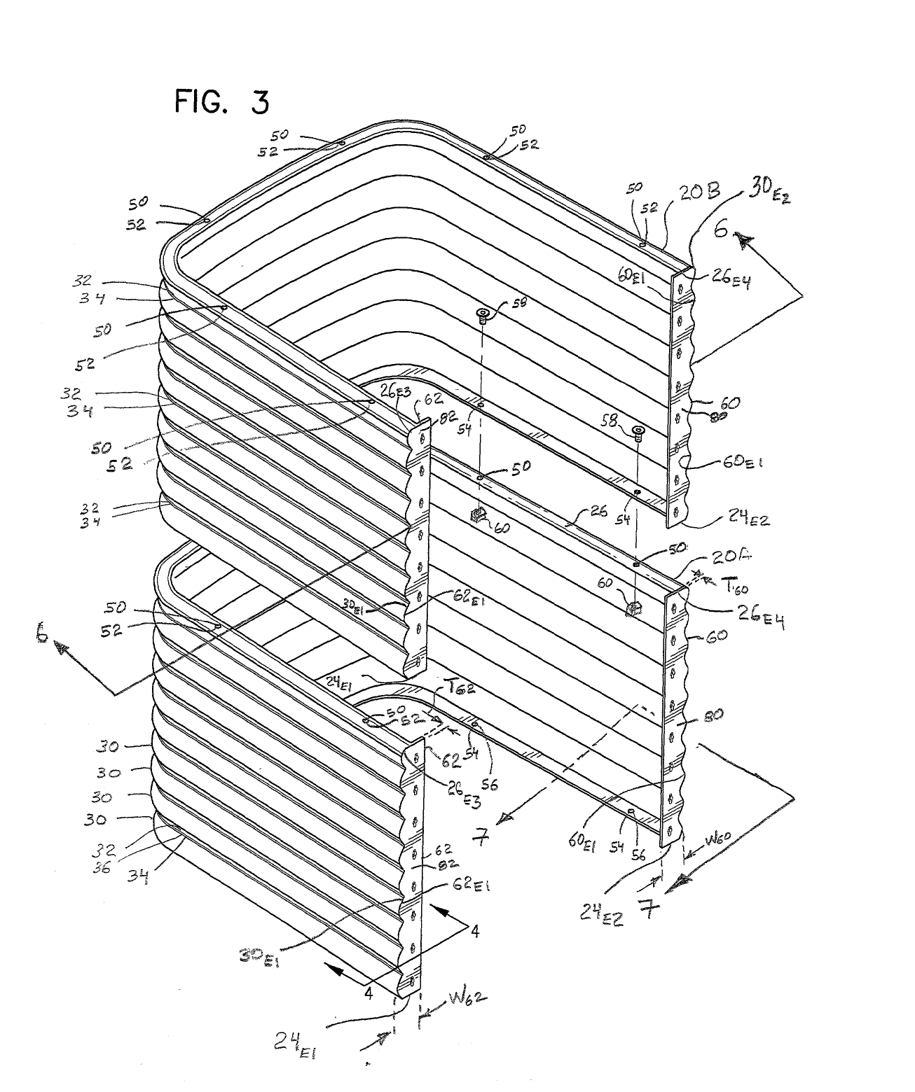

Attention is directed to FIG. 1 of the drawing, where a window well structure 20 is shown as placed against a finished foundation wall 22 to protect window 16 against earth 18. Window well structure 20 single part construction, i.e. only uses one reversible section of stackable window well structures 20. The basic design is to provide a lower rim member 24, and stacked thereabove, an upper rim member 26, each of which rim members may (but are not limited to) be provided as flat, generally U-shaped or C-shaped members as appropriate. The lower rim member 24 extends between a first end 24_{E1}, and a second end 24_{E2}. The upper rim member 26 extends between a third end 24_{E3} and a fourth end 24_{E4}. Extending along a generally vertically oriented plane, between lower rim member 24 and upper rim member 26, are a plurality of corrugations 30. As seen in FIGS. 3, 4, and 7, between corrugations 30, and in the embodiment illustrated, located at the inward inflection point between corrugations, a groove cutout 36 is defined between a pair of horizontally running parallel first 32 and second 34 edges. For ease in performing the cutting operation, the groove may be oriented coplanar with the horizontal axis of the corrugations 30. A u-shaped groove 36 can be (but is not necessarily) provided having at the bottom of the groove a flat region, at least a portion of which is preferably aligned substantially vertically between lower rim member 24 and upper rim member 26. Using groove 36, the window well structure 20 can be cut as through section 6-6 noted in FIG. 3, such as by a power or hand saw, between the edges 32 and 34 (see FIG. 7), to leave a suitable upper end surface 40 as noted in FIG. 6, to allow an overall structure of selected assembled height. H.

For securing a first window well structure 20A to a second window well structure 20B, in upper rim 26 of a lower window well structure 20A, a plurality of apertures 50 are provided defined by hole edges 52. In the lower rim 24 of a second window well structure 20B, a plurality of apertures 54 are provided defined by hole edges 56. Suitable fastening systems such as threaded bolts 58 and nuts 60 are used to secure the upper rim 26 and lower rim 24 together.

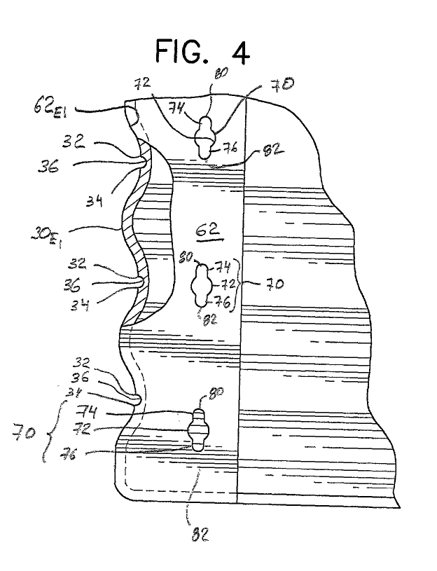

As seen in FIGS. 2 and 4, inward turning first 60 and second 62 flanges are provided. The inward turning feature is advantageous since this allows visual inspection of the fasteners such as nails 64 that are used to affix the window well structures 20 to the foundation 22. In the design illustrated, in each of flanges 60 and 62, reversible fastening receiving keyhole apertures 70 are provided. Each keyhole apertures 70 includes a central, preferably circular apertures portion 72, and extending therefrom, and upper 74 and lower 76 U-shaped keyhole extension portions. Ideally, and as illustrated herein, the keyhole apertures 70 are reversible, i.e., are mirror images whether placed with a first end 80 up or with a second end 82 up (see FIG. 4).

The first 60 and second 62 edge flanges are preferably integrally molded with the rest of the window well structure 20, in an outside width W₆₀ or W₆₂. Each flange 60 is also normally provided in a narrow thickness T₆₀ or T₆₂, but sufficiently robust that the window well structure 20 can be securely affixed to foundation 22. The vertically extending edge flanges 60 and 62 have a rear surface 80 and 82, respectively, that fits flush within the surface of foundation 22. To complete the pleasing visual appearance, and corrugations 30 have first ends 30E1 and second ends 30E2 that are coterminous with the outward end 60E1 of flange 60, and with the outward end 62E1 of flange 62, respectively. Also, as indicated in FIG. 2, note that for structural and visual purposes, an angle alpha (α) between flanges 60 or 62 and the adjacent vertical plane of the corrugations of slightly more than 90 degrees, or more preferably of about 92 degrees or so, is advantageous, as this also is helpful in the molding process.

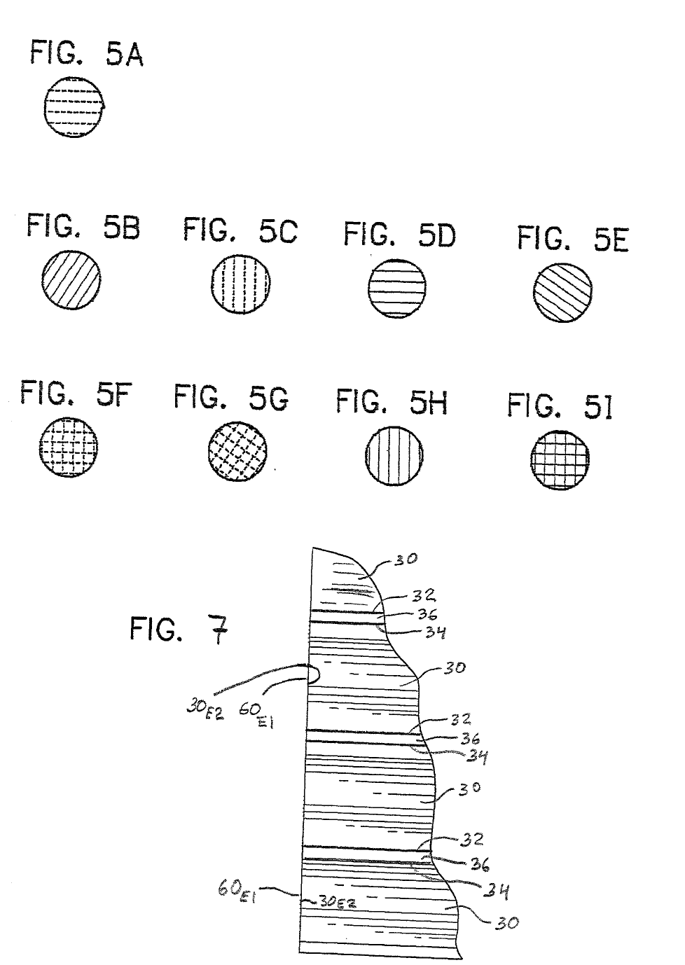

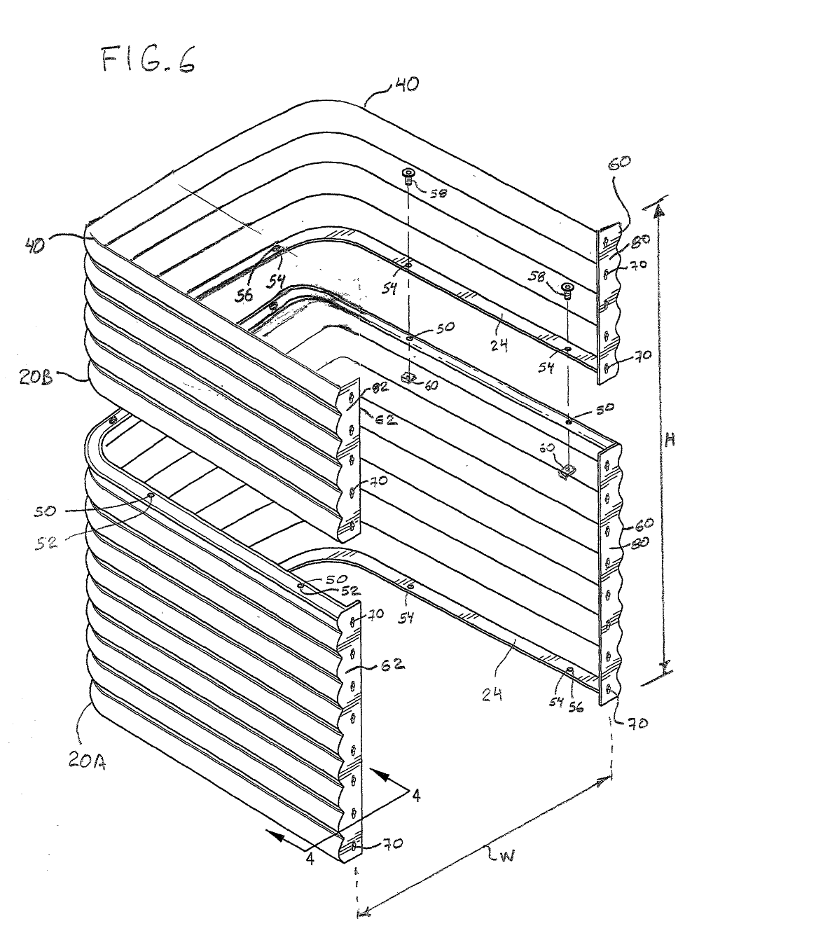

The window well structure disclosed herein is ideal for manufacture as an integral, one-piece window well structure by injection molding or rotomoldingx of a suitable plastic. During the plastic preparation process, a suitable plastic can be developed having a color selected from one of the following: colors: (a) red or pink, (b) brown, (c) violet or purple, (d) green, (e) blue, (f) gray or silver, (g) orange, (h) yellow or gold, (i) or black, all as further noted in FIG. 1 and FIGS. 5A through 5I. Also, the window well structure can be provided in a variety of widths W (see FIG. 6, approximately measured as the width between opposing keyhole passageways in first and second flanges), including popular sizes of (a) approximately twenty four inches in width, (b) approximately thirty six inches in width, (c) approximately forty eight inches in width, or (d) approximately sixty inches in width.

It is to be appreciated that the various aspects and embodiments of the crawl access and basement window well supports as described herein are an important improvement in the state of the art of structures and materials for crawl access and basement window wells. A plastic window well as described herein is virtually non-destructible by insects, vermin, and the elements. Importantly, such a window well is environmentally friendly, in that no metal oxides are released to the environment as would be the case with steel or galvanized steel window well structures. Although only a few exemplary embodiments have been described in detail, various details are sufficiently set forth in the drawings and in the specification provided herein to enable one of ordinary skill in the art to make and use the invention(s), which need not be further described by additional writing in this detailed description. Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. A window well structure, said structure comprising
(a) a lower rim, said lower rim comprising a shaped frame member having a first end and a second end;
(b) an upper rim, said upper rim comprising a shaped frame member having a third end and a fourth end;
(c) a corrugated body extending between said lower rim and said upper rim; said corrugated body forming a generally vertical structural wall between said lower rim and said upper rim, said corrugated body having a plurality of corrugations with an inward inflection point between adjacent corrugations, said corrugated body having an external surface, said external surface further comprising one or more groove cutouts defined between first and second edges.

2. The window well structure as set forth in claim 1, further comprising
(a) a first flange running vertically between said first and said third ends, and
(b) a second flange running vertically between said second and said fourth ends
(c) said first flange and said second flange each integrally formed with said corrugated body.

3. The window well structure as set forth in claim 2, wherein said corrugated body has an outer surface oriented along a vertical plane, and wherein said first flange and said second flange each have a flange face, and wherein said flange face is oriented on a plane perpendicular to said vertical plane of said corrugated body.

4. The window well structure as set forth in claim 3, wherein each of said first and said second flanges has an outward edge end, and wherein said outward edge end of said first and said second flange also defines first and second ends of said corrugated body.

5. The window well structure as set forth in claim 1, wherein said upper rim is provided in a flat, u-shaped configuration.

6. The window well structure as set forth in claim 2, wherein said lower rim is provided in a flat, u-shaped configuration.

7. The window well structure as set forth in claim 2, wherein said first flange or said second flange further comprises a plurality of reversible keyhole passageways therethrough, said reversible keyhole passageways comprising a central aperature of a first diameter, extending above and below said central aperture, a first and a second u-shaped fastener securing portion.

8. The window well structure as set forth in claim 2, wherein said reversible keyhole passageways are provided as mirror image structures about the center of said central aperture.

9. The window well structure as set forth in claim 2, wherein said first flange further comprises at least one nail socket, said at least one nail socket adapted to secure a nail therein.

10. The window well structure as set forth in claim 2, wherein said second flange further comprises at least one nail socket, said at least one nail socket adapted to secure a nail therein.

11. A window well structure, said structure comprising
(a) a first window well portion, said first window well portion comprising
(1) a lower rim, said lower rim comprising a flat, u-shaped frame member having a first end and a second end;
(2) an upper rim, said upper rim comprising a flat, u-shaped frame member having a third end and a fourth end;
(3) a corrugated body extending between said lower rim and said upper rim; said corrugated body forming a generally vertical structural wall between said lower rim and said upper rim, said corrugated body having a plurality of corrugations with an inward inflection point between adjacent corrugations, said corrugated body having located at one or more of said inward inflection points an external surface further comprising a groove defined by fist and second edges, said groove having therein an intermediate land which is substantially flat.
(4) a first flange running vertically between said first and said third ends, and
(5) a second flange running vertically between said second and said fourth ends
(6) said first flange and said second flange each integrally formed with said corrugated body; and
(b) a second window well structure portion, said second window well structure portion comprising
(1) a lower rim, said lower rim comprising a flat, unshaped frame member having a first end and a second end;
(2) a corrugated body, said corrugated body having a plurality of corrugations with an inward inflection point between adjacent corrugations, said corrugated body having located at one or more of said inward inflection points an external surface further comprising a groove defined by fist and second edges, said groove having therein an intermediate land which is substantially flat, said corrugated body extending upward from said lower rim to a termination land, said termination land occurring at said inflection point between adjacent corrugations, said termination land having a fifth end and a sixth end, said corrugated body forming a generally vertical structural wall between said lower rim and termination land, said upper rim
(3) a first flange running vertically between said first and said fifth ends, and
(4) a second flange running vertically between said second and said sixth ends
(5) said first flange and said second flange each integrally formed with said corrugated body;

12. The apparatus as set forth in claim 11, wherein said upper rim further comprises a plurality of apertures defined by edge wall portions.

13. The apparatus as set forth in claim 12, wherein said lower rim further comprises a plurality of apertures defined by edge wall portions.

14. The apparatus as set forth in claim 12, further comprising a plurality of fasteners, and wherein said first window well structure portion and said second window well structure portion are securely joined by said fasteners, by securing with said fasteners the upper rim of said first window well structure portion to said lower rim of said second window well structure portion.

15. The apparatus as set forth in claim 2, wherein each of said first and second edge flanges are turned inward.

16. The apparatus as set forth in claim 1, wherein said window well structure comprises an injection moldable plastic.

17. The apparatus as set forth in claim 14, wherein said window well structure color is selected from one of the following:
(a) red or pink;
(b) brown;
(c) violet or purple;
(d) green;
(e) blue;
(f) gray or silver;
(g) orange;
(h) yellow or gold;
(i) black.

18. The window well structure as set forth in claim 1, wherein the overall height is approximately twenty-four inches.

19. The window well structure as set forth in claim 7, wherein the overall width between said keyhole passageways in said first flange and said keyhole passageways in said second flange is selected from the group consisting of (a) approximately twenty four inches, (b) approximately thirty six inches, (c) approximately forty eight inches, or (d) approximately sixty inches.

20. The window well structure as set forth in claim 7, wherein a plurality of keyhole passageways are provided in each of said first and said second flanges, and wherein said keyhole passageways are spaced vertically approximately three inches on center.

21. The window well structure as set forth in claim 1, wherein a groove is located as one or more of said inward inflection points an external surface of said corrugations.
